(19) United States
(12) Patent Application Publication
(10) Pub. No.: US 2005/0111529 A1
(43) Pub. Date: May 26, 2005

(54) TONE DETECTION USING A CDMA RECEIVER

(75) Inventor: Wayne H. Bradley, West Chicago, IL (US)

Correspondence Address: FOLEY & LARDNER, 321 NORTH CLARK STREET, SUITE 2800, CHICAGO, IL, 60610-4764, US

(73) Assignee: PRAIRIECOMM, INC., Rolling Meadows, IL (US)

(21) Appl. No.: 10/904,196

(22) Filed: Oct. 28, 2004

Related U.S. Application Data
(63) Continuation-in-part of application No. 09/791,950, filed on Feb. 22, 2001.

(51) Int. Cl. H04B 1/69

(52) U.S. Cl. 375/148

(57) ABSTRACT

A code division multiple access (CDMA) receiver can detect the presence of a GSM tone-based signal by programming the digital filter's tap weights to correlate with a GSM FCCH signal. If the correlation between the values of the tap weights and a received signal satisfies a threshold, the receiver produces an indication that a GSM signal is present. Post-processing can be performed on the output of the digital filter to improve signal detection based on the determination of the correlation of the received signal with the digital filter, the determination of the corresponding power value, the determination of the signal strength; and the estimation of the frequency offset.

### CROSS-REFERENCE TO RELATED PATENT APPLICATIONS

This application is a continuation-in-part of U.S. patent application Ser. No. 09/791,950 entitled “Signal Detection Using A CDMA receiver,” filed on Feb. 22, 2001, and is expressly incorporated herein by reference in its entirety.

### FIELD OF THE INVENTION

The present invention relates to signal detection in communications systems. More particularly, the present invention relates to the detection of tone-based, non-CDMA signals using a CDMA receiver.

### BACKGROUND OF THE INVENTION

One of the key benefits of mobile communications is the ability to maintain communications while moving throughout various geographic areas. Different geographic areas can have different protocol-based infrastructures that can therefore call for the transmission of wireless signals according to different wireless communications protocols. Because of the differences in the types of infrastructures, some mobile units are able to process information according to any one of the time division multiple access (TDMA), code division multiple access (CDMA) and global system for mobile communications (GSM) standards. For example, near major metropolitan areas a mobile unit may need to exchange information with CDMA base stations. Conversely, in other areas, GSM base stations can be prevalent and a mobile unit may need to exchange information according to the GSM format in such locations.

The details of the TDMA protocol are disclosed in the IS-136 communication standard, which is available from the Telecommunication Industry Association (TIA). The details of the GSM protocol are available from the European Telecommunications Standards Institute. Third generation CDMA standards are typically referred to as wideband CDMA. The most prevalent wideband CDMA standards that are currently being developed are the IS-2000 standard, which is an evolution of the IS-95 protocol, and the uniform mobile telecommunication system (UMTS) protocol, which is an evolution of the GSM protocol. As used herein, code division multiple access (CDMA) refers to the third generation wideband CDMA protocol employed in the universal mobile telecommunication system (UMTS) standard.

GSM and UMTS are both European standards and accordingly their respective infrastructures are primarily located near the same geographic areas, as compared to the TDMA standard which is a North American standard and is primarily located in the United States. Given such, mobile units are therefore more likely to need receivers that facilitate CDMA/GSM detection than receivers which facilitate CDMA/TDMA detection. As GSM is a tone-based signal, there may also be a need for a CDMA receiver to be able to receive other tone-based cellular signals that are not of the CDMA format.

The GSM media access scheme is a combination of frequency division multiplex access (FDMA) and time division multiple access (TDMA). In FDMA, a user is assigned to and transmits over a portion of the frequency spectrum. The frequency spectrum can quickly become saturated since only one user can access the assigned frequency at a time. In order to increase the number of users who can use a given frequency, TDMA is employed to divide the frequency spectrum into time slots within which users can transmit information. As a result, multiple users can share a frequency, and each user can transmit during his respective time slot. Each user is assigned a burst of time in which to transmit or receive data. Multiple bursts comprise a frame.

The GSM standard calls for two 25 MHz frequency bands for user data. The frequency band between 890 and 915 MHz is the uplink channel, used for communications from the mobile unit to the base station; and the frequency band between 935 and 960 MHz is the downlink channel, used for communications from the base station to the mobile unit. Each uplink and downlink channel is divided into 124 carrier frequencies over which communication takes place. Each carrier frequency is divided into time slots called multiframes, and a multiframe is made up of 26 frames. Each frame has eight time slots called bursts, and a user can transmit in one burst per frame. There is no data transmitted over the first carrier, as it is used as a guard band to separate the GSM signals from other signals that can be transmitted on carrier frequencies that neighbor on the guard band. The base station within a cell is assigned to communicate with mobile units over assigned carrier frequencies.

GSM calls are initialized by the Frequency Correction Channel (FCCH) which is a part of the GSM beacon signal transmitted on its broadcast channel. The FCCH is a type of control channel used for connection of calls and general network management. The FCCH channel can be used by active or idle mobile units and supplies the mobile unit with the frequency of the GSM system in order to enable the mobile unit to synchronize with the network. A mobile unit can detect the presence of a GSM signal by listening for the FCCH complex tone.

In conventional systems, a receiver can only detect the presence of a signal of its same type. Detection of a signal typically requires a mobile unit to power up a portion of hardware that is dedicated to detecting the corresponding type of signal. For example, while communicating with a base station, a mobile unit having a CDMA receiver can be required to power up its GSM receiver hardware to merely determine if a GSM signal is present. However, this technique is costly in terms of mobile unit battery life and processing demands placed on the mobile unit. Generally, wireless communications are transmitted between units that are mobile, and these mobile units are typically designed to be compact and therefore have limited battery and processing capabilities. As a result, the reduction in battery life and increase in processing demands, which result from the current technology, is especially troublesome. Therefore there is a need for a system that allows mobile units to detect various types of signals using a single receiver.

### SUMMARY OF THE INVENTION

In embodiments of the present invention, a CDMA receiver can detect the presence of a tone-based signal (e.g., global system for mobile communications (GSM) signal). Post-processing can be performed on the output of the digital filter to improve signal detection based on the determination of the correlation of the received signal with the digital filter, the determination of the corresponding power value, the determination of the signal strength; and the estimation of the frequency offset. As used herein, code division multiple access (CDMA) refers to the third generation wideband CDMA protocol employed in the universal mobile telecommunication system (UMTS) standard. Embodiments of the present invention can maintain battery life and alleviate the threat of increased processing demands by preventing the mobile unit from having to power up additional receivers to merely detect the presence of tone-based non-CDMA signals.

According to one aspect of the present invention, a method of using a code division multiple access (CDMA) receiver having a digital filter can be employed to detect the presence of a complex tone within received signals. The complex tone can have a symbol rate and can be comprised of a known sequence. In such an arrangement, the complex tone can be of a global system for mobile communications (GSM) signal. Furthermore, the method can include the steps of determining the values of the tap weights for a digital filter; programming the digital filter with the values of the tap weights; determining a correlation between a received signal and the values of the tap weights; and indicating the presence of a detected complex tone if the correlation satisfies a threshold. The method can also include post-processing which can be performed on the output of the digital filter. Post-processing can be performed to improve signal detection based on the determination of the correlation between the received signal and the digital filter, the determination of the corresponding power value, the determination of the signal strength, and the estimation of the frequency offset.

According to a second aspect of the present invention, a code division multiple access (CDMA) receiver can detect the presence of a complex tone within received signals. The complex tone can have a symbol rate and can be comprised of a known sequence. In such an arrangement, the complex tone can be a tone-based signal such as the global system for mobile communications (GSM) signal. Further, post-processing can be performed on the output of the digital filter. Post-processing can be performed to improve signal detection based on the determination of the correlation between the received signal and the digital filter, the determination of the corresponding power value, the determination of the signal strength; and the estimation of the frequency offset. In such an arrangement, the CDMA receiver can include a digital filter having a plurality of taps each having a programmable tap weight, wherein the digital filter is adapted to correlate the received signal with the programmable tap weights. The CDMA receiver can also include a controller that is configured to: (i) determine the values of the tap weights, wherein the controller can further be configured to program the digital filter with the tap weights; (ii) determine the correlation between a received signal and the values of the tap weights; (iii) and indicate the presence of a complex tone if the correlation calculated by the digital filter satisfies a threshold.

According to a third aspect of the present invention, a code division multiple access (CDMA) receiver can detect the presence of a complex tone within received signals. The complex tone can have a symbol rate and can be comprised of a known sequence. In such an arrangement, the complex tone can be a tone-based signal such as the global system for mobile communications (GSM) signal. The CDMA receiver can include memory, a processor and a digital filter.

The processor within the CDMA receiver can also receive instructions as follows. A first set of instructions can be stored on the memory and adapted to cause the processor to determine values of the tap weights. A second set of instructions can be stored on the memory and adapted to cause the processor to program the digital filter of the receiver with the tap weights. A third set of instructions can be stored on the memory and adapted to cause the processor to determine the correlation between a received signal and the values of the tap weights of the digital filter. A fourth set of instructions can be stored on the memory and adapted to cause the processor to indicate the presence of a complex tone if the correlation calculated by the digital filter satisfies a threshold. A fifth set of instructions can be stored on the memory and adapted to cause the processor to conduct post-processing on the outputs of the digital filter. Post-processing can include determining the correlation between the received signal and the digital filter, determining the corresponding power value, determining the signal strength, and estimating the frequency offset.

According to a fourth aspect of the present invention, a computer code product can enable a code division multiple access (CDMA) receiver to detect the presence of a complex tone within received signals. The complex tone can have a symbol rate and can be comprised of a known sequence. The instructions in the computer code product can be executed to perform the following instructions. A first set of instructions can be stored on the memory and adapted to cause the processor to determine values of the tap weights. A second set of instructions can be stored on the memory and adapted to cause the processor to program the digital filter of the receiver with the tap weights. A third set of instructions can be stored on the memory and adapted to cause the processor to determine the correlation between a received signal and the values of the tap weights of the digital filter. A fourth set of instructions can be stored on the memory and adapted to cause the processor to indicate the presence of a complex tone if the correlation satisfies a threshold. The computer code product can further comprise a fifth set of instructions that can be stored on the memory and adapted to cause the processor to conduct post-processing. Post-processing can include determining the correlation between the received signal and the digital filter, determining the corresponding power value, determining the signal strength, and estimating the frequency offset.

These and other features of embodiments of the present invention will be apparent to those of ordinary skill in the art in view of the description of the preferred embodiments, which is made with reference to the drawings, a brief description of which is provided below.

### BRIEF DESCRIPTION OF THE DRAWINGS

FIG. 1 is an exemplary diagram of a CDMA receiver 100 that can be used for GSM signal detection according to an embodiment of the present invention.

FIG. 2 is an exemplary flow diagram illustrating a method of GSM signal detection 200 according to an embodiment of the present invention.

FIG. 3 is an exemplary flow diagram illustrating a method of post-processing to improve signal detection 300 according to an embodiment of the present invention.

FIG. 4 is an exemplary flow diagram illustrating a method of post-processing to estimate frequency offset 400 according to an embodiment of the present invention.

FIG. 5 is an exemplary flow diagram illustrating a method of post-processing to determine and compare signal strength 500 according to an embodiment of the present invention.

FIG. 6 is an exemplary block diagram of a CDMA receiver 600 disposed to implement an embodiment of the present invention.

FIG. 7 is an exemplary diagram of a Post-processor 700 that can be used for GSM signal detection according to an embodiment of the present invention.

FIG. 8 is an exemplary diagram of a cellular network 800 that utilizes a CDMA receiver for GSM signal detection according to an embodiment of the present invention.

### DETAILED DESCRIPTION OF THE PREFERRED EMBODIMENTS

In an embodiment of the present invention, a CDMA receiver is capable of detecting the presence of tone-based differently formatted signals, by programming a CDMA digital filter with appropriate tap weights. Therefore the CDMA receiver can eliminate the necessity to power-up receiver hardware or to execute software instructions that are specific to the particular format of received communication signals. Post-processing can be performed to improve signal detection based on the determination of the correlation between the received signal and the digital filter, the determination of the corresponding power value, the determination of the signal strength; and the estimation of the frequency offset. As used herein, code division multiple access (CDMA) refers to the third generation wideband CDMA protocol employed in the universal mobile telecommunication system (UMTS) standard. As used herein, differently formatted signals include any signals that are not formatted according to a CDMA format. One example that is described in detail below is the use of a CDMA receiver to detect the presence of GSM signals. Although the detection of GSM signals using a CDMA receiver is described, it should be readily understood that such an example is merely illustrative. Embodiments of the present invention could be used to detect the presence of other tone-based signals as well.

As part of detecting the presence of GSM signals, signals from the CDMA searcher can be processed to ensure such signals have acceptable correlation properties. Once GSM signals are detected, GSM-specific hardware and/or software can be implemented to receive and process the GSM signals in a known manner.

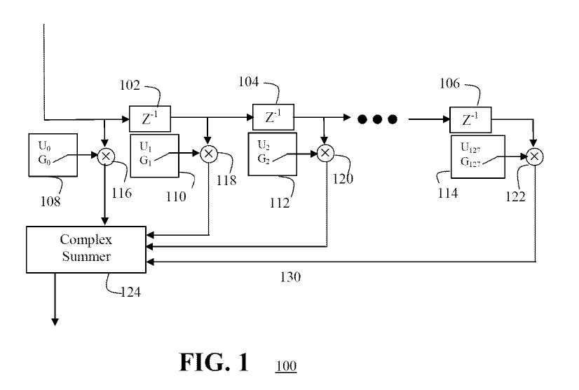

As shown in FIG. 1, the CDMA receiver 100 can include a number of delay blocks, three of which are shown at reference numerals 102, 104, and 106, the inputs and outputs of which can be coupled to a number of multipliers, four of which are shown at reference numerals 108, 110, 112, and 114. The CDMA receiver 100 can also include a number of programmable tap weights, shown at reference numerals 108, 110, 112, and 114, which can also be coupled to the multipliers 108, 110, 112, and 114. The outputs of the multipliers 108, 110, 112, and 114 can each be coupled to a Complex Summer 124, which can add the output of the multipliers 108, 110, 112, and 114 together. The CDMA receiver 100 can include 128 multipliers and 128 programmable tap weights. However, the CDMA receiver 100 can include any other suitable number of taps, summers and multipliers.

During operation of the CDMA receiver 100, digital samples can be coupled into and clocked through the cascaded arrangement of delay blocks 102, 104, and 106 in the CDMA receiver 100 at the CDMA chip rate that can be, for example 3.84 MHz. As the chips are clocked through the delay blocks 102, 104, and 106, the chips can be multiplied by the programmable tap weights shown in blocks 108, 110, 112, and 114, the values of which can be controlled by the CDMA receiver 100 to produce a measurement of the correlation between the received chips and the programmable tap weights.

When the CDMA receiver is intended to process CDMA signals, the programmable tap weights 108, 110, 112, and 114 can be set to U₀, U₁, U₂, . . . U₁₂₇ so that a known portion of a CDMA signal (e.g., a pseudorandom sequence) can produce a high correlation when the CDMA signal is time aligned with the tap weights 108, 110, 112, and 114. Accordingly, the CDMA receiver 100 can determine when the received signal is time aligned by monitoring the output of the Complex Summer 124 and looking for a peak correlation.

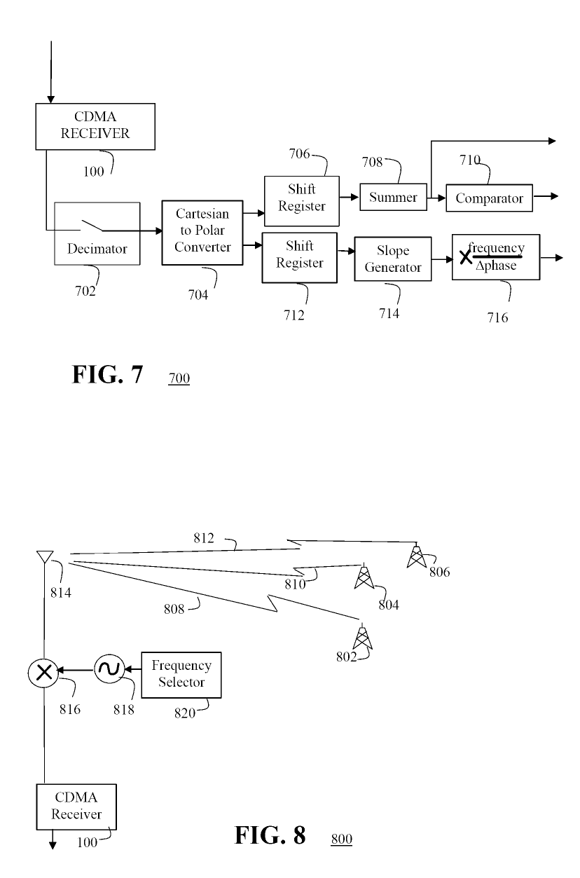

While the foregoing has described the operation of the CDMA receiver 100 for the reception of CDMA signals, the CDMA receiver 100 can also be used to detect the presence of a tone-based signal such as a GSM signal. By changing the programmable weights 108, 110, 112, and 114, the receiver can detect CDMA signals as well as GSM signals. In particular, the CDMA receiver 100 can set the programmable weights 108, 110, 112, and 114 to G₀, G₁, G₂, . . . G₁₂₇ so that a received signal having a known GSM sequence therein can yield a relatively large sum at the output of the Complex Summer 124. FIG. 7 depicts the processing that can be required for a Post-processor 700. For UMTS, the CDMA chip rate is 3.84 MHz and for GSM the symbol rate is 270.833 KHz. A possible configuration of the CDMA receiver 100 can have 128 taps that are clocked at the CDMA chip rate. This configuration of the CDMA receiver 100 can correlate the received signal and the taps over a time equivalent to approximately 9 GSM symbols. A positive correlation over 9 unique symbols can be present for at least 14 sequential occurrences because the GSM FCCH signal has a known portion that can be 142 symbols in length. Although a single correlation value may be sufficient for detection of the presence of a GSM signal in some environments, processing the full FCCH signal of 142 symbols can increase the detection probability and decrease the false alarm rate. A Decimator 702 can be used to sample the output from the CDMA receiver 100. This could generate a sequence of correlation values. These correlation values can be complex and therefore can be converted to a power and a phase angle with a Cartesian to Polar Converter 704. A sequence of power values can be stored in a Shift Register 706, and accumulated by a Summer 708 in order to determine, in a Comparator 710, if a threshold has been satisfied and, therefore, whether a GSM FCCH signal has been detected. The Shift Register 706 and the Summer 708, used jointly, can function as an averaging finite impulse response (FIR) filter, which can carry out the function of accumulating the sequence of power values. The Shift Register 706 can store each value sequentially and discard the oldest value once the full capacity of the Shift Register 706 is reached. If the Cartesian to Polar Converter 704 is omitted, the sequence of correlation values can be stored in the Shift Register 706. A power value corresponding to the correlation may be computed before or after the Summer 708. In addition to providing an input to the Comparator 710, the output of the Summer 708 can provide a signal strength indication that can be stored and compared to the output of the Summer 708 at a different time.

The threshold can be set empirically based on a fixed level above a noise floor that is commonly produced by the summer 124 of FIG. 1 when no correlation exists. Alternatively, the threshold can be set to a fixed value relative to the scale of an analog to digital converter (A/D). Additionally, the Comparator 710 can provide synchronization or correlation timing information to a GSM receiver to indicate the time at which the FCCH signal was detected.

The Post-processor 700 can also operate on the phase angles output from the Cartesian to Polar Converter 704 in order to determine the frequency offset of the received signal. A sequence of phase angles can be stored in a Shift Register 712, and the change in phase between sequential output correlations (i.e. the slope) can also be determined in a Slope Generator 714. Next, the amount that the phase change (i.e. the phase slope) deviates from a predetermined phase change can be determined. Finally, the frequency offset can be determined by scaling the input to block 716 based on a comparison of the amount of the phase change between sequential correlations and its relationship to the frequency.

Each frequency offset may correspond to a phase deviation from the normal rotation of the FCCH tone. An ideal FCCH tone rotates by π/2 every symbol. When there is no frequency offset, the phase can advance by 4 37/72π from one phase angle value to another phase angle 128 chips later. Any multiple of 2π can be ignored in this calculation because the expected frequency offset is not expected to cause a phase change greater than 2π. For an example, if there is a frequency offset of 1 kHz and 128 chips are processed, the phase change could be calculated to be 37π/72+π/15. The number of phase angles can be the same as the number of powers that were used when the maximum detection criteria was met.

FIG. 8 shows a cellular network 800 in which the CDMA receiver 100 may be employed. Base Stations 802, 804, and 806 can transmit signals 808, 810, and 812 that are received at antenna 814. Signals 808, 810, and 812 can be tone-based signals such as GSM signals or CDMA signals and can be sent on carrier frequencies. The carrier frequency can be converted to baseband by applying the antenna output and a tone from an Oscillator 818 to a Frequency Down-converter 816. The Frequency Selector 820 can set the frequency of the tone. If there is a measured frequency offset, the Oscillator 818 can be adjusted to compensate for the frequency offset and reception quality can thereby be improved. The frequency offset can be the offset that is estimated by the Post-Processor 700 in FIG. 7 and can be used as feedback to the Oscillator 818 to adjust its frequency offset.

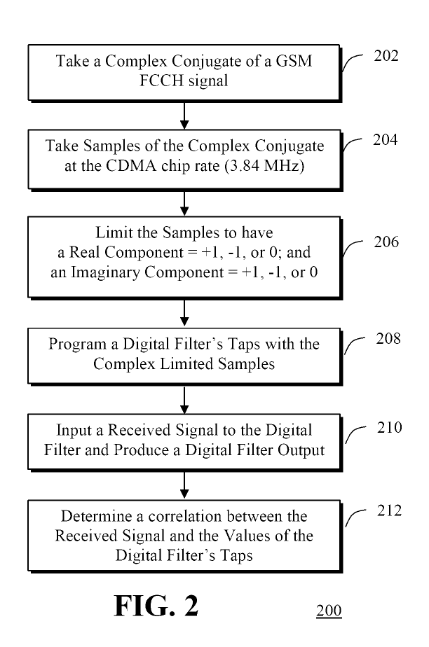

As shown in FIG. 2, GSM detection can be described by a flow diagram 200. It should be understood that functions described herein using the flow diagrams can be implemented by software instructions or can be implemented by specially programmed hardware. The software instructions could be stored in any computer readable medium and executed by a processor. The functionality described in connection with the flow diagrams should not be construed to be limited to particular hardware, software or hardware/software implementations.

A complex conjugate of a GSM FCCH signal can be taken at step 202 and samples of the complex conjugate can be taken at the CDMA chip rate (3.84 MHz) at step 204. The samples can typically be in fixed-point resolution because this will typically be a digital system. Generally, a CDMA signal is modulated according to the quadrature phase shift keying (QPSK) technique and therefore the complex filter taps need only take values such as +/−1+/−i. At step 206, the system can limit the samples to have a real component with a number value equal to numbers such as +1, −1, or 0; and an imaginary component with a number value equal to numbers such as +1, −1, or 0. The values can be modified if the CDMA signal for which the filter is designed is, for example, quadrature amplitude modulation (QAM), and the tap weight resolution is more than one bit. The digital filter's taps can be programmed with the complex limited samples at step 208. Then a received signal can be input into the digital filter and a digital filter output can be produced at step 210. Next, the correlation between the received signal and the values of the digital filter's taps can be determined at step 212.

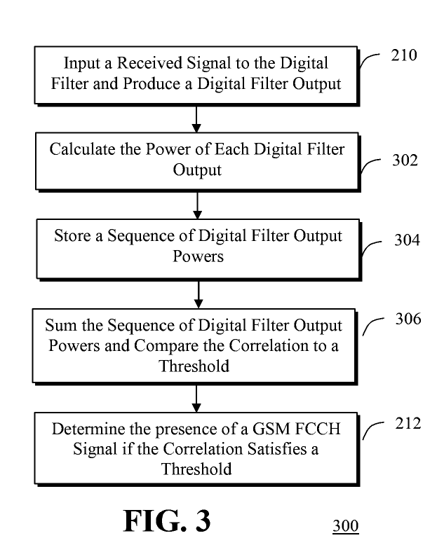

FIG. 3 is an exemplary flow diagram illustrating a technique of post-processing to improve signal detection 300 according to an embodiment of the present invention. A received signal is input into the digital filter and a digital filter output is produced at step 210. The power of each digital filter output can be determined at step 302, and a sequence of digital filter outputs can be stored at step 304. The rate at which the digital filter output powers are stored may be slower than the CDMA chip rate. The sequence of digital filter output powers can be summed, and the correlation, which can correspond to the sum can be compared to the threshold at step 306. The storing and summing functions within steps 304 and 306 can serve an accumulating function and can accumulate the sequence of powers to generate the sum. The presence of a GSM FCCH signal can be indicated if the correlation satisfies a threshold at step 212. The threshold selection was discussed in reference to the Comparator 710 in FIG. 7.

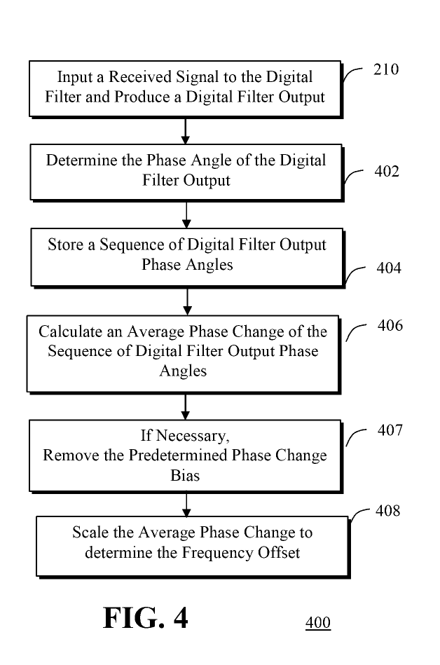

FIG. 4 is flow diagram illustrating a method of post-processing to estimate frequency offset 400 according to an embodiment of the present invention. Following step 210 of FIG. 2, the phase angle of the digital filter output can be determined at step 402, and a sequence of digital filter output phase angles can be stored at step 404. As with the digital filter output powers, the rate at which the digital filter output phase angles are stored may be slower than the CDMA chip rate. An average phase change of the sequence of digital filter output phase angles can be calculated at step 406. Based on the rate that the digital filter outputs phase angles are stored, a predetermined phase change bias may need to be removed from the average phase change. If necessary, the predetermined phase change bias can be removed at step 407. Referring to the description of FIG. 7, the predetermined phase change bias could be 37π/72 for phase angles of digital filter outputs separated by 128 CDMA chips. Once the bias is accounted for, the average phase change can be scaled to determine the frequency offset at step 408. For example, the average phase change for phase angles of digital filter outputs separated by 128 CDMA chips could be scaled by 3.84 MHz/256.

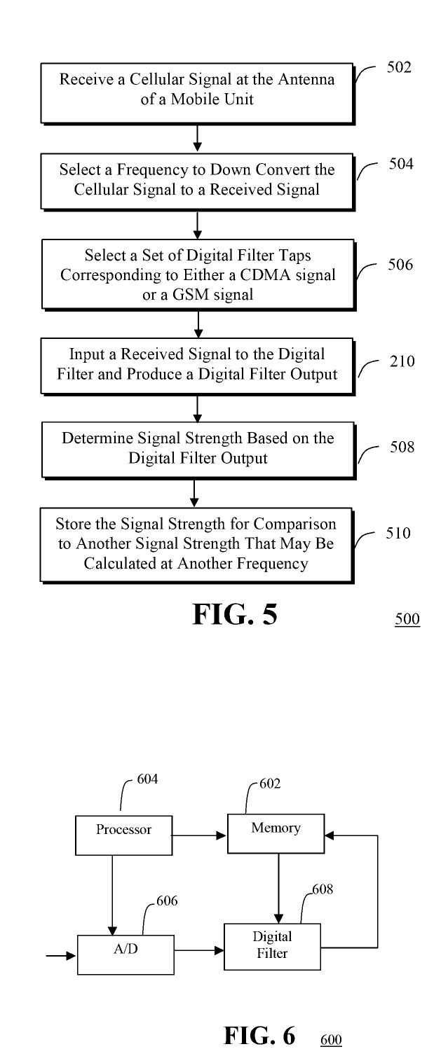

FIG. 5 is an exemplary flow diagram illustrating a method of post-processing to determine and compare signal strength 500 according to an embodiment of the present invention. First, a cellular signal can be received at the antenna of a mobile unit at step 502. The cellular signal may be from one or more base stations 802, 804 and/or 806. A frequency on which to down convert the cellular signal to a received signal can be selected at step 504, and a set of digital filter taps corresponding to either a CDMA signal or a tone-based signal such as a GSM signal can be selected at step 506. A received signal can be input into the digital filter and can produce a digital filter output at step 210. The signal strength can be based on the digital filter output at step 508, and the signal strength can be stored for comparison to another signal strength corresponding to a signal received on another frequency at step 510.

The signal strength can have a one-to-one relationship with the correlation value of a received signal. Therefore the signal strength can increase as the correlation between the received signal and the values of the digital filter's taps increases. The signal strength determination can be done for any number of frequencies on which various base stations may transmit signals. For the case when received signals from more than one base station are correlated between the digital filter's taps and more than one correlation satisfies the threshold, the CDMA receiver 100 can identify the signal with the greatest signal strength, and referring to FIG. 8, the Frequency Selector 820 can select the frequency corresponding to the base station that transmitted that signal. For instance, the Frequency Selector 820 can choose a frequency corresponding to base station 802, 804 or 806 depending upon whichever base station transmitted the signal with the greatest signal strength that also has a correlation that satisfies the threshold.

Referring to FIG. 6, the receiver of the communication device 600 can comprise memory 602, a processor 604, a digital filter 608, and an A/D 606.

The processor 604 can be implemented in either software or hardware or a software/hardware implementation.

The memory 602 can store the values of the tap weights after they are determined. Exemplary types of memory that can be used to carry out an embodiment of the present invention include, but are not limited to, Read Only Memory (ROM) and Random Access Memory (RAM). Read Only Memory is a permanent form of memory that retains the contents of the memory even after the device in which the memory is located is powered off. ROM can be used to store instructions adapted to cause the processor to determine the values of the tap weights, program the digital filter of the receiver with the tap weights, determine the correlation between received signals and the tap weight values and indicate the presence of a GSM signal. The values of the tap weights can be stored in various types of memory in which data can be written including, but not limited to, RAM.

The A/D 606 can be controlled by the processor 604 and can pass samples of the received signal to the Digital Filter 608.

The digital filter 608 can perform the filtering of the received signal with the values of the tap weights supplied by the memory 602.

Detection of differently formatted signals, such as the GSM FCCH signal, can take place in mobile or stationary units which can include, but are not limited to, a cellular telephone, a wireless laptop and a personal computer that communicates over both wireless and wireline channels. The network over which the communication can travel can be wireless or wired, and the communication can travel from a network to a base station that can then transmit a signal over the wireless channel to the mobile unit. The device from which the information that is communicated originates can be any number of mobile or stationary units including, but not limited to, another cellular telephone, an internet server, or a personal computer.

The present invention can also be implemented as part of a computer code product. A computer code product can comprise computer readable language and a computer readable storage medium. The computer readable language can be the set of instructions (e.g., source code) that dictates the operations that the processor takes according to an embodiment of the present invention. The computer readable storage medium can be the location in which the computer code product is stored.

The computer readable language can include, but is not limited to, source code. Exemplary computer readable storage mediums can include, but are not limited to, ROM and paper on which the computer code product can be written and then transferred to and run on a processor of the type, including, but not limited to, that found in 604.

The computer readable language can be executed to cause the processor 604 to determine the values of the tap weights; program the digital filter of the receiver with the tap weights; determine the correlation between a received signal and the values of the tap weights of the digital filter; and indicate the presence of a complex tone if the correlation calculated by the digital filter satisfies a threshold. The computer readable language can also be executed to cause the processor 604 to conduct post-processing. Post-processing can include determining the correlation between the received signal and the digital filter, determining the corresponding power value, determining the signal strength, and estimating the frequency offset.

Numerous modifications and alternative embodiments of the present invention will be apparent to those skilled in the art in view of the foregoing description. Accordingly, this description is to be construed as illustrative only and not as limiting to the scope of the invention. The details of the structure can be varied substantially without departing from the spirit of the invention, and the exclusive use of all modifications, which are within the scope of the appended claims, is reserved.

1. A method of using a code division multiple access receiver having a digital filter to process a received signal, at a first carrier frequency, containing a complex tone represented by a known signal, the method comprising:
determining a plurality of tap weights for a digital filter;
programming the digital filter with the plurality of tap weights;
determining a correlation between the received signal and the plurality of tap weights; and
indicating a presence of a complex tone if the correlation satisfies a threshold.

2. The method of claim 1, wherein the plurality of tap weights is determined by the steps of:
taking a complex conjugate of the known signal; and
digitizing the complex conjugate at a predetermined rate.

3. The method of claim 2, wherein the predetermined rate is a CDMA chip rate.

4. The method of claim 1, wherein the known signal is a GSM FCCH signal.

5. The method of claim 1 wherein the plurality of tap weights are complex values.

6. The method of claim 1, wherein the plurality of tap weights are stored in memory.

7. The method of claim 1, wherein the correlation is between a portion of the received signal and the plurality of tap weights.

8. The method of claim 1, wherein the correlation is based on a sequence of digital filter outputs.

9. The method of claim 8, wherein the sequence of digital filter outputs is processed to determine the presence of a complex tone by performing the steps of:
calculating a power corresponding to each digital filter output to produce a sequence of powers;
accumulating the sequence of powers to generate the correlation; and
comparing the correlation to a threshold to indicate the presence of a complex tone if the correlation satisfies a threshold.

10. The method of claim 9, wherein the step of accumulating the sequence of powers is accomplished by an averaging FIR filter.

11. The method of claim 9, wherein the correlation is a first measure of received signal strength for the first carrier frequency.

12. The method of claim 11, wherein the first measure of received signal strength for the first carrier frequency is compared to a second measure of received signal strength for a second carrier frequency.

13. The method of claim 8, further comprising the step of calculating a frequency offset by the steps of:
calculating a phase of each digital filter output to produce a sequence of phases;
calculating an average change of phase between each sequential phase in the sequence of phases;
if necessary, removing a predetermined phase change bias; and
determining the frequency offset based upon the average change of phase.

14. A code division multiple access receiver having a digital filter to process a received signal, at a first carrier frequency, containing a complex tone represented by a known signal, the receiver comprising:
a digital filter including a plurality of taps, wherein each tap having a programmable tap weight, the digital filter adapted to correlate the received signal with the programmable tap weight values; and
a controller configured to determine values of the tap weights, program the digital filter with the tap weights, determine the correlation between the received signal and the values of the tap weights, and indicate the presence of a complex tone if the correlation calculated by the digital filter satisfies a threshold.

15. The receiver of claim 14, wherein the plurality of tap weights is determined by the steps of:
taking a complex conjugate of the known signal; and
digitizing the complex conjugate at a predetermined rate.

16. The receiver of claim 15, wherein the predetermined rate is a CDMA chip rate.

17. The receiver of claim 14, wherein the known signal is a GSM FCCH signal.

18. The receiver of claim 14 wherein the plurality of tap weights are complex values.

19. The receiver of claim 14, wherein the plurality of tap weights are stored in memory.

20. The receiver of claim 14, wherein the correlation is between a portion of the received signal and the plurality of tap weights.

21. The receiver of claim 14, wherein the correlation is based on a sequence of digital filter outputs.

22. The receiver of claim 21, wherein the sequence of digital filter outputs is processed to determine the presence of a complex tone by the steps of:
calculating a power corresponding to each digital filter output to produce a sequence of powers;
accumulating the sequence of powers to generate the correlation; and
comparing the correlation to a threshold to indicate the presence of a complex tone if the correlation satisfies a threshold.

23. The receiver of claim 22, wherein accumulating the sequence of powers is accomplished by an averaging FIR filter.

24. The receiver of claim 22, wherein the correlation is a first measure of received signal strength for the first carrier frequency.

25. The receiver of claim 24, wherein the first measure of received signal strength for the first carrier frequency is compared to a second measure of received signal strength for a second carrier frequency.

26. The receiver of claim 21, further comprising the step of calculating a frequency offset by the steps of:
calculating a phase of each digital filter output to produce a sequence of phases;
calculating an average change of phase between each sequential phase in the sequence of phases;
if necessary, removing a predetermined phase change bias; and
determining the frequency offset based upon the average change of phase.

27. A code division multiple access receiver having a digital filter to process a received signal, at a first carrier frequency, containing a complex tone represented by a known signal, the receiver comprising:
memory;
a processor;
a digital filter;
a first set of instructions stored on the memory and adapted to cause the processor to determine values of the tap weights;
a second set of instructions stored on the memory and adapted to cause the processor to program the digital filter of the receiver with the tap weights;
a third set of instructions stored on the memory and adapted to cause the processor to determine the correlation between a received signal and the values of the tap weights of the digital filter; and
a fourth set of instructions stored on the memory and adapted to cause the processor to indicate the presence of a complex tone if the correlation calculated by the digital filter satisfies a threshold.

28. The code division multiple access receiver, further comprising a fifth set of instructions stored on the memory and adapted to cause the processor to conduct post-processing on the outputs of the digital filter.

29. The receiver of claim 27, wherein the plurality of tap weights is determined by the steps of:
taking a complex conjugate of the known signal; and
digitizing the complex conjugate at a predetermined rate.

30. The receiver of claim 29, wherein the predetermined rate is a CDMA chip rate.

31. The receiver of claim 27, wherein the known signal is a GSM FCCH signal.

32. The receiver of claim 27 wherein the plurality of tap weights are complex values.

33. The receiver of claim 27, wherein the plurality of tap weights are stored in memory.

34. The receiver of claim 27, wherein the correlation is between a portion of the received signal and the plurality of tap weights.

35. The receiver of claim 27, wherein the correlation is based on a sequence of digital filter outputs.

36. The receiver of claim 35, wherein the sequence of digital filter outputs is processed to determine the presence of a complex tone by the steps of:
calculating a power corresponding to each digital filter output to produce a sequence of powers;
accumulating the sequence of powers to generate the correlation; and
comparing the correlation to a threshold to indicate the presence of a complex tone if the correlation satisfies a threshold.

37. The receiver of claim 36, wherein accumulating the sequence of powers is accomplished by an averaging FIR filter.

38. The receiver of claim 36, wherein the correlation is a first measure of received signal strength for the first carrier frequency.

39. The receiver of claim 38, wherein the first measure of received signal strength for the first carrier frequency is compared to a second measure of received signal strength for a second carrier frequency.

40. The receiver of claim 35, further comprising the step of calculating a frequency offset by the steps of:
calculating a phase of each digital filter output to produce a sequence of phases;
calculating an average change of phase between each sequential phase in the sequence of phases;
if necessary, removing a predetermined phase change bias; and
determining the frequency offset based upon the average change of phase.

41. A computer code product which can enable a code division multiple access receiver to process a received signal, at a first carrier frequency, containing a complex tone represented by a known signal, wherein the instructions in the computer code product can be executed according to the following:
a first set of instructions stored on the memory and adapted to cause the processor to determine values of the tap weights;
a second set of instructions stored on the memory and adapted to cause the processor to program the digital filter of the receiver with the tap weights;
a third set of instructions stored on the memory and adapted to cause the processor to determine the correlation between a received signal and the values of the tap weights of the digital filter; and
a fourth set of instructions stored on the memory and adapted to cause the processor to indicate the presence of a complex tone if the correlation calculated by the digital filter satisfies a threshold.

42. The computer code product of claim 41, wherein the instructions in the computer code product can be further executed according to a fifth set of instructions stored on the memory and adapted to cause the processor to conduct post-processing on the outputs of the digital filter.

43. The computer code product of claim 41, wherein the plurality of tap weights is determined by the steps of:
taking a complex conjugate of the known signal; and
digitizing the complex conjugate at a predetermined rate.

44. The computer code product of claim 43, wherein the predetermined rate is a CDMA chip rate.

45. The computer code product of claim 41, wherein the known signal is a GSM FCCH signal.

46. The computer code product of claim 41 wherein the plurality of tap weights are complex values.

47. The computer code product of claim 41, wherein the plurality of tap weights are stored in memory.

48. The computer code product of claim 41, wherein the correlation is between a portion of the received signal and the plurality of tap weights.

49. The computer code product of claim 41, wherein the correlation is based on a sequence of digital filter outputs.

50. The computer code product of claim 49, wherein the sequence of digital filter outputs is processed to determine the presence of a complex tone by the steps of:
calculating a power corresponding to each digital filter output to produce a sequence of powers;
accumulating the sequence of powers to generate the correlation; and
comparing the correlation to a threshold to indicate the presence of a complex tone if the correlation satisfies a threshold.

51. The computer code product of claim 50, wherein the step of accumulating the sequence of powers is accomplished by an averaging FIR filter.

52. The computer code product of claim 50, wherein the correlation is a first measure of received signal strength for the first carrier frequency.

53. The computer code product of claim 52, wherein the first measure of received signal strength for the first carrier frequency is compared to a second measure of received signal strength for a second carrier frequency.

54. The computer code product of claim 49, further comprising the step of calculating a frequency offset by the steps of:
calculating a phase of each digital filter output to produce a sequence of phases;
calculating an average change of phase between each sequential phase in the sequence of phases;
if necessary, removing a predetermined phase change bias; and
determining the frequency offset based upon the average change of phase.
